(19) United States
(12) Patent Application Publication
(10) Pub. No.: US 2019/0147407 A1
(43) Pub. Date: May 16, 2019

(54) AUTOMATED HIRING ASSESSMENTS

(71) Applicant: INTERNATIONAL BUSINESS MACHINES CORPORATION, ARMONK, NY (US)

(72) Inventors: Shanthan Chamala, Malvern, PA (US); Perumalla S. Sailaja, Visakhapatnam (IN)

(21) Appl. No.: 15/814,963

(22) Filed: Nov. 16, 2017

(51) Int. Cl. G06Q 10/10; G06Q 10/06

(52) U.S. Cl. CPC G06Q 10/1053; G06Q 10/063112

(57) ABSTRACT

An embodiment of the invention may include a computing device for determining an aptitude of a job candidate. The embodiments may include a computing device that receives a job role. The embodiments may include a computing device that determines characteristics associated with the job role. The embodiments may include a computing device that determines a job candidate that meets a threshold number of the characteristics. The embodiments may include a computing device that creates an assessment to test the characteristics. The assessment includes combining a plurality of questions based on a relevance of each question to the characteristic. The plurality of questions are questions the job candidate does not have a valid assessment score for the characteristic. The embodiments may include a computing device that determines an aptitude of the job candidate based on answers provided to the plurality of questions.

### BACKGROUND

The present invention relates to assessing job candidates, and more specifically, to automating hiring assessments.

Companies use pre-hire assessments as part of the recruitment process. In instances where a large number of candidates apply, it becomes administratively impossible to validate the skills (and skill levels) mentioned in the candidate resumes. By not assessing the skills properly, there is a risk that the company may lose good candidates, or the company might not place candidates in the right positions that will utilize the candidate skills to the fullest.

### BRIEF SUMMARY

An embodiment of the invention may include a method, computer program product and computer system for operating a computing device for determining an aptitude of a job candidate. The embodiments may include a computing device that receives a job role. The embodiments may include a computing device that determines characteristics associated with the job role. The embodiments may include a computing device that determines a job candidate that meets a threshold number of the characteristics. The embodiments may include a computing device that creates an assessment to test the characteristics. The assessment includes combining a plurality of questions based on a relevance of each question to the characteristic. The plurality of questions are questions the job candidate does not have a valid assessment score for the characteristic. The embodiments may include a computing device that determines an aptitude of the job candidate based on answers provided to the plurality of questions.

### BRIEF DESCRIPTION OF THE DRAWINGS

FIG. 1 illustrates an automated candidate assessment system, in accordance with an embodiment of the invention;

FIG. 2 is a flowchart illustrating the operations of the candidate assessment program of FIG. 1, in accordance with an embodiment of the invention;

FIG. 3 is a flowchart illustrating the operations of the candidate assessment program of FIG. 1, in accordance with an additional embodiment of the invention;

FIG. 4 is a block diagram depicting the hardware components of the automated candidate assessment system of FIG. 1, in accordance with an embodiment of the invention;

FIG. 5 depicts a cloud computing environment according to an embodiment of the present invention; and

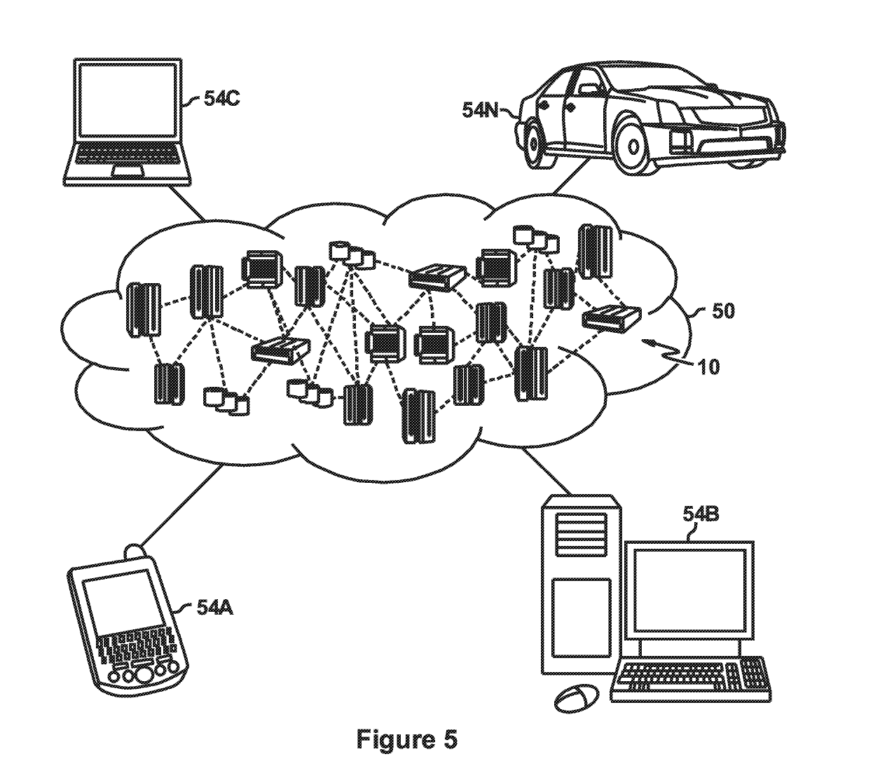

FIG. 6 depicts abstraction model layers according to an embodiment of the present invention.

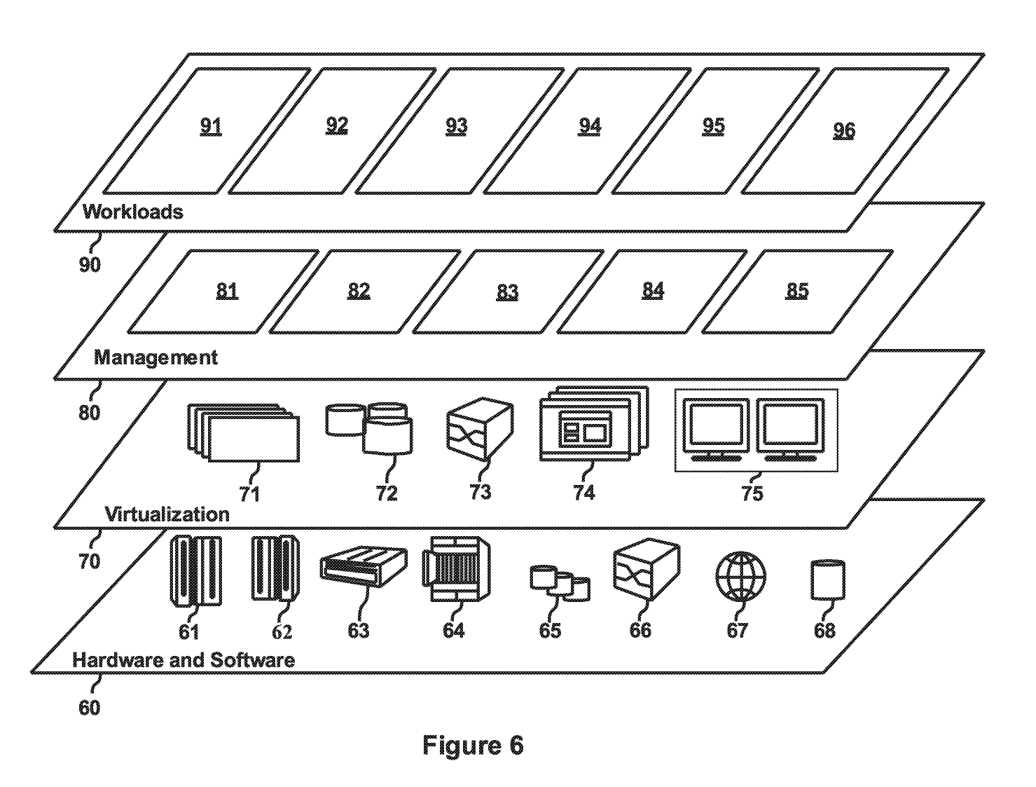

### DETAILED DESCRIPTION

Embodiments of the present invention will now be described in detail with reference to the accompanying Figures.

Efficient management of people is essential to creating a productive work environment. Employees that are not properly qualified for a position may struggle to meet the demands required of them. Additionally, employees that are placed in positions in which they may be overqualified can become bored and lose motivation. The burden of finding qualified candidates for an organization, and placing them for the right roles can be time consuming and fraught with individual biases. Assessments may be used to measure a candidate's characteristics and qualifications, but may be cumbersome to create a test that can measure a candidate's aptitude for one or more job roles, while not burdening the candidate by being tested on material that they've previously shown an aptitude for. Described below is a system for tailoring an assessment to an individual candidate for one or more open jobs in a company, and providing the results of that assessment to the relevant hiring managers in order to properly place the candidate.

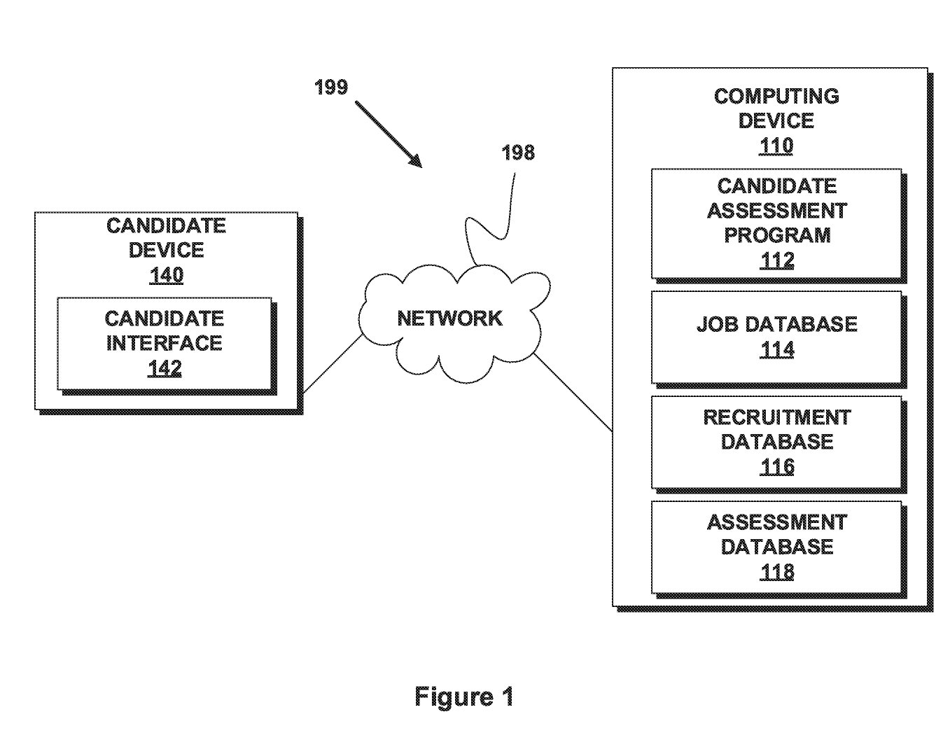

FIG. 1 illustrates automated candidate assessment system 199, in accordance with an embodiment of the invention. In an example embodiment, automated candidate assessment system 199 includes a Computing Device 110 and a Candidate Device 140 interconnected via a network 198.

In the example embodiment, network 198 is the Internet, representing a worldwide collection of networks and gateways to support communications between devices connected to the Internet. Network 198 may include, for example, wired, wireless or fiber optic connections. In other embodiments, network 198 may be implemented as an intranet, a local area network (LAN), or a wide area network (WAN). In general, network 198 can be any combination of connections and protocols that will support communications between the Computing Device 110 and the Candidate Device 140.

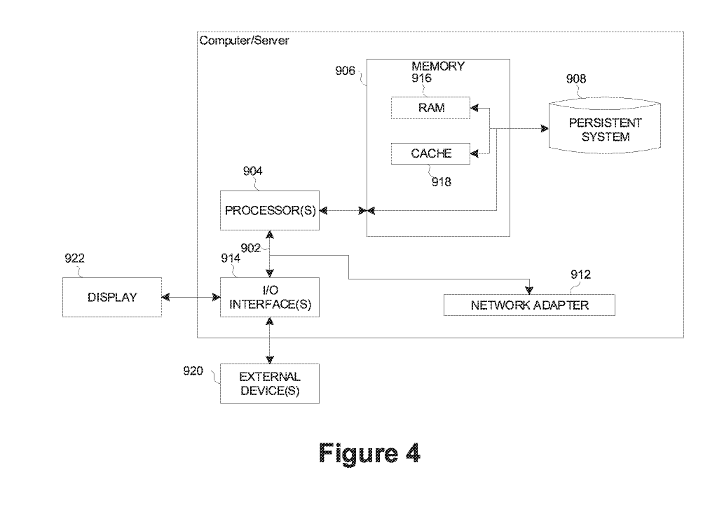

Candidate Device 140 may include a Candidate Interface 142. Candidate Device 140 may be a desktop computer, a notebook, a laptop computer, a tablet computer, a handheld device, a smart-phone, a thin client, or any other electronic device or computing system capable of receiving and sending data to and from other computing devices such as Computing Device 110 via network 198. In an example embodiment, Candidate Device 140 is a computing device that is optimized for the support of websites which reside on Candidate Device 140, such as Candidate Interface 142, and for the support of network requests related to websites which reside on Candidate Device 140. Candidate Device 140 is described in more detail with reference to FIG. 4.

Candidate Interface 142 is a program residing on candidate device that is capable of interfacing with the programs located on Computing Device 110, and performing actions in coordination with the candidate assessment Candidate Assessment Program 112. Candidate Interface 142 includes components used to receive input from a user and transmit the input to an application residing on Computing Device 110. In an example embodiment, Candidate Interface 142 uses a combination of technologies and devices, such as device drivers, to provide a platform to enable users of Computing Device 110 to interact with Candidate Assessment Program 112. In the example embodiment, Candidate Interface 142 receives input, such as textual input received from a physical input device, such as a keyboard, via a device driver that corresponds to the physical input device. Candidate Interface 142 may allow a job candidate to apply, or upload documentation, to a Job Database 114. Additionally, Candidate Interface 142 may be used to provide assessments, or tests, based on instructions from candidate assessment Candidate Assessment Program 112.

Computing Device 110 includes Candidate Assessment Program 112, Job Database 114, Recruitment Database 116, and Assessment Database 118. In the example embodiment, Computing Device 110 is a desktop computer, a notebook or a laptop computer; however, in other embodiments, Computing Device 110 may be a smart phone, a tablet computer, a handheld device, a thin client, or any other electronic device or computing system capable of receiving and sending data to and from Candidate Device 140 via network 198, and capable of operating a graphical user interface. Although not shown, optionally, Candidate Device 140 can comprise a cluster of web servers executing the same software to collectively process the requests for the web pages as distributed by a front end server and a load balancer. Computing Device 110 is described in more detail with reference to FIG. 4.

Job Database 114 is a collection of information detailing the characteristics of a plurality of jobs. Job Database 114 may contain a plurality of job roles used in current or previous job candidate searches, and may have corresponding skill, or characteristic, requirements related to the job role. Additionally, Job Database 114 may contain managerial assessments of job candidates based on the job candidate's performance in a job role, as well as assessments of the candidate prior to, or currently, working in the job role. Job Database 114 may contain a history of all job descriptions for a single employer (e.g. a database internal to a single company), and/or a history of public job descriptions on a public board (e.g. job postings on a website).

Recruitment Database 116 is a collection of information detailing the characteristics of a plurality of job candidates. Recruitment Database 116 may be a collection of qualifications, skills, credentials, and previous employment for individual job candidates. Recruitment Database 116 may contain a history of all job candidates that applied to a single employer (e.g. a database internal to a single company), and/or listings on a publicly available website (e.g. candidate profiles on a website). Additionally, Recruitment Database 116 may contain assessment scores for individual job candidates. The assessment scores may apply to public assessments (e.g. university entrance exams), or tests privately administered by an employer.

Assessment Database 118 is a collection of questions to assess the skills or characteristics of a candidate. The questions may also contain information on how relevant a question is for a specific job role, and any relevant predictive quality of that question for performance in the job role.

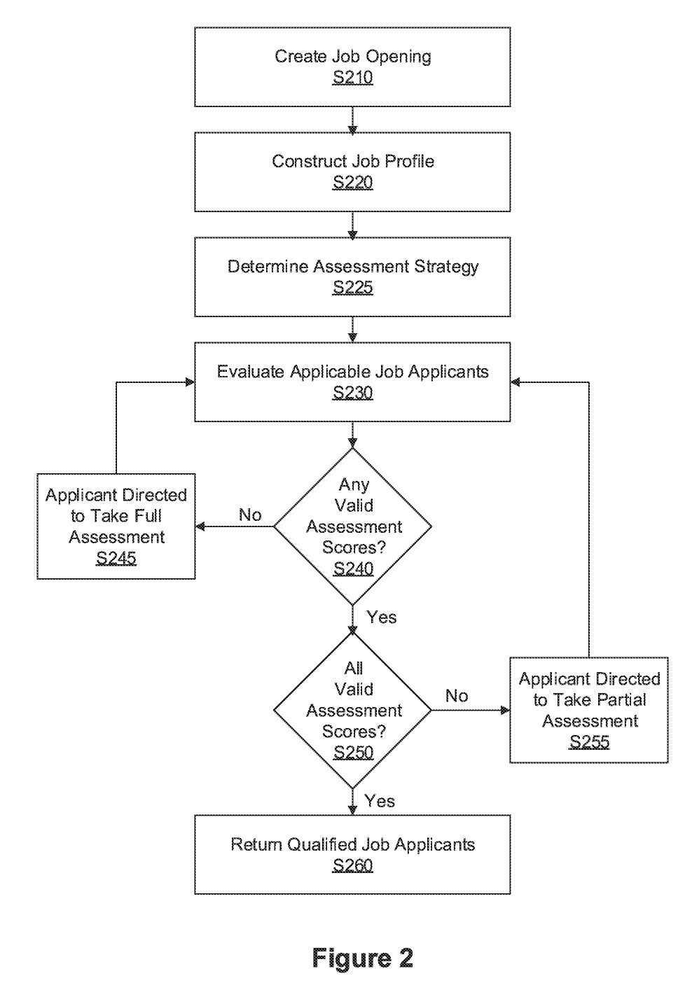

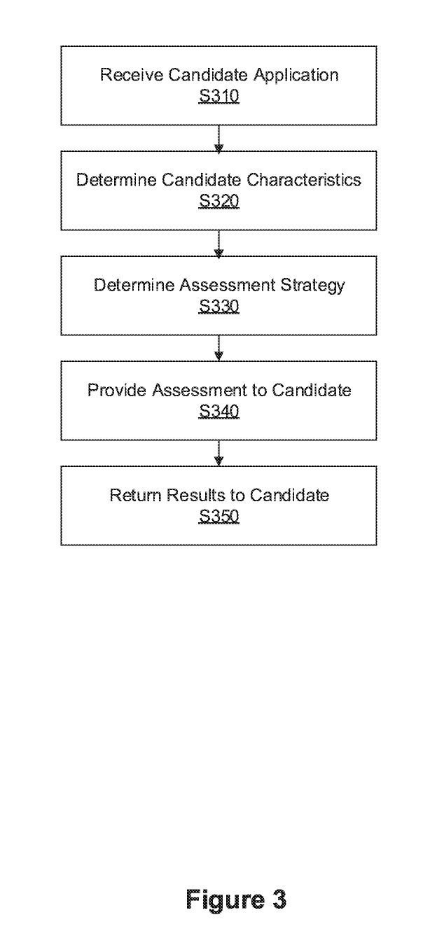

Candidate Assessment Program 112 is a software application capable of receiving a request from an employer to fill a vacancy for a job role, as well as the capability to assess candidates applying to a job role. The job role may be any titles, functions, duties, or responsibilities the employer may require an individual to perform. The Candidate Assessment Program 112 may create a job profile based on similar job roles from a Job Database 114. The job profile may be any licenses, assessments, degrees, employment history, or other quantifiable criterion that could be used to make a determination on the qualifications of a job candidate. The Candidate Assessment Program 112 may then search the Recruitment Database 116 for job candidates matching one or more of the characteristics of the job profile. The Candidate Assessment Program 112 may check Assessment Database 118 for any assessments taken by qualifying job candidates. Candidates that have all of the required assessments may then be presented to the employer as meeting the search criterion. Candidates that have not met the required assessments may be directed to take any necessary assessments to meet the minimum threshold required by the employer. The operations and functions of Candidate Assessment Program 112 are described in further detail below with regard to FIG. 2 and FIG. 3.

FIG. 2 is a flow chart illustrating how Candidate Assessment Program 112 determines qualified candidates for a job role. Referring to step S210, an employer creates a job role. The employer may input as much or as little information into the job role as desired. In one example, the employer may submit a job role stating a job title such as “web developer.” In another embodiment, the employer may submit a job role containing criterion such as “3+years programming java,” “project management,” and “10+years in web development.”

Referring to step S220, Candidate Assessment Program 112 may construct a job profile based on the job role submitted in step S210. The job profile may be created by comparing the information submitted by the employer as the job role to similar job roles contained in Job Database 114. Candidate Assessment Program 112 may use natural language processing techniques to determine similarities between the employer submitted job role and the job roles contained in Job Database 114. Candidate Assessment Program 112 may return characteristics based on the similarities between the job role submitted in step S210 and the job roles contained in Job Database 114.

In one embodiment, characteristics may be added to the job profile when such characteristics are contained in a threshold number of candidate searches. For example, if a threshold is set at 75% and 80% of job profiles for “computer programmer” require a degree in computer science, the characteristic of a computer science degree would be added to the job role.

Additionally, or alternatively, characteristics may be returned that are indicative of a candidate's success in a job role based on performance evaluations of candidates that were hired for similar job roles. For example, if 80% of all other computer programmers (i.e. job recipients) at that company that performed undergraduate research received “exceeds expectation” evaluations (i.e. a high-performance rating), the characteristic of undergraduate research would be added as a preferred characteristic of the job role.

Still referring to step S220, different characteristics may have varying degrees of importance for a job role. Thus, the characteristics may be weighted based on their importance in performing the role. For example, for a web developer job role, understanding how to write computer code may be necessary, while an understanding of Java may only be preferred, and other skills such as, for example, experience interacting with customers and leadership experience may be optional. Thus, the threshold for a candidate to meet the threshold, and the weights of each characteristic, may be set such that the candidate must have any necessary characteristics to be considered, but only need a combination other preferred or optional characteristics to achieve the threshold.

Referring to step S225, Candidate Assessment Program 112 may determine an assessment strategy by selecting questions from Assessment Database 118 based on the characteristics contained in the job profile. The assessment strategy may contain a plurality of questions that are retrieved from Assessment Database 118, where each question measures a characteristic. The questions may be randomly selected from a list of questions for each trait to be assessed, or selected based on specific criterion to put together an assessment to determine a level of skill of a specific trait. For example, a test may be created having varying degrees of difficulties of test questions, in order to gauge the proficiency of a candidate in that skill. In a separate embodiment, the test may be dynamic, in that the questions provided to the candidate increase in difficulty if they are answered correctly, or decrease in difficulty if they are answered incorrectly. Similar to above, assessment questions may be selected based on their correlation to job performance for a job role, or for job roles all requiring a specific characteristic.

Referring to step S230, Candidate Assessment Program 112 may evaluate candidates based on the job profile and assessment strategy. Candidate Assessment Program 112 returns all candidates that meet a threshold number of the characteristics contained in the job profile or obtained through previous passing scores relating to aspects of the assessment strategy. The candidates may be selected from recruitment database 116, or alternatively be direct applicants to a posting for the job. Additionally, Candidate Assessment Program 112 may return candidates that achieve a threshold score based on a weighted scoring of their characteristics. Candidate Assessment program may determine threshold scores for passing based on normalizing assessment scores across all test takers, to identify candidates that overachieve with respect to other candidates.

Referring to step S240, Candidate Assessment Program 112 may determine if a candidate that met the job profile has any valid assessment scores. A valid assessment score may be any score on file that meets a passing score of an aspect of the assessment strategy. If there are no valid assessment scores, candidate assessment program proceeds to step S245. If there are any valid assessment scores, candidate assessment program proceeds to step S250.

Referring to step S245, Candidate Assessment Program 112 may issue a full assessment to the candidate. The full assessment may be a test having one or more questions selected to assess a candidate's proficiency for a job role. The questions may address all aspects of the job role that could feasibly be tested such as, for example, computer language syntax for programmers, applicable laws related to a job role, or language proficiency. A full assessment may be a standard test, or standard set of test questions, given to new applicants for a specific position. Following the completion of the full assessment, the results may be stored in assessment database, and candidate assessment program may return to step S230 to assess the candidate.

Referring to step S250, Candidate Assessment Program 112 may determine if a candidate that met the job profile has all valid assessment scores. A valid assessment score may be any score on file that meets a passing score of an aspect of the assessment strategy. If there are only some valid assessment scores, candidate assessment program proceeds to step S255. If there are all valid assessment scores, candidate assessment program proceeds to step S260.

Referring to step S255, Candidate Assessment Program 112 may issue a partial assessment to the candidate. The partial assessment may be a test having one or more questions selected to assess a candidates proficiency for aspects of a job role that were not previously tested. The questions may address aspects of the job role that could feasibly be tested such as, for example, computer language syntax for programmers, applicable laws related to a job role, or language proficiency. Following the completion of the partial assessment, the results may be stored in assessment database, and candidate assessment program may return to step S230 to assess the candidate.

Referring to step S260, Candidate Assessment Program 112 may return a list of candidates suitable for a job role. Additionally, candidate assessment program may schedule any necessary secondary steps prior to hiring a candidate such as, for example, contacting references, scheduling an interview, and contacting education institutions.

FIG. 3 is a flow chart illustrating how Candidate Assessment Program 112 determines job roles for a candidate. Referring to step S310, candidate assessment program receives a candidate's application. Candidate application may be received by interfacing with a candidate using, for example, Candidate Interface 142 located on Candidate Device 140. Using Candidate Interface 142, the candidate may upload a resume, credentials, licenses, job history and any other relevant information to Candidate Assessment Program 112 for a specific job posting, or as a general inquiry. Candidate Assessment Program 112 may store take all the relevant information supplied by the candidate and store it in Recruitment Database 116.

Referring to step S320, Candidate Assessment Program 112 creates a characteristic profile for the candidate. Candidate Assessment Program 112 may use natural language processing techniques to digest the information contained in, for example, the resume, and build a characteristic profile for a candidate, which is stored in Recruitment Database 116. Additionally, Candidate Assessment Program 112 may use natural language processing techniques to recognize characteristics included in other candidate information such as, for example, licenses and credentials.

Referring to step S330, Candidate Assessment Program 112 determines whether a candidate is suitable for any specific position. Candidate Assessment Program 112 may compare characteristics of the candidate to characteristics required, or preferred, for a job role. Candidate Assessment Program 112 may determine an assessment strategy for a candidate based on the job which the candidate applied to, or any other jobs that are suitable for the candidate, based on the materials submitted by the candidate, and any previous assessments taken by the candidate. In one embodiment, an assessment may be created based on a difference between previous assessments taken by the candidate, and the traits required for a new job role. Candidate Assessment Program 112 may do this using the techniques laid out in steps S225-S250 above.

Referring to step S340, Candidate Assessment Program 112 may provide the assessment to the candidate, through Candidate Interface 142. The assessment may be a list of test question to gauge a candidate's characteristics or traits.

Referring to step S350, Candidate Assessment Program 112 may return suitable job roles to the candidate, which a candidate may select as a job role to be considered for. Additionally, steps S330-S350 may be applied for any new jobs that are entered into job database 111 by an employer, which may prompt a candidate to take further assessments to gauge the candidate's competency and interest. The job roles may be based on assessment scores attained during step S340, as well as the characteristics provided by the candidate. Additionally, all aspects of the candidate's profile may be stored in Recruitment Database 116.

In an example embodiment of the above system, elements of candidate assessment program 112 may be periodically re-run based on new information contained in job database 114, recruitment database 116, and assessment database 118. For example, in an instance where an employer did not find an adequate applicant to hire for a first job, step S230 may be periodically re-run, and proceed through step S260. This may allow candidate assessment program to prompt any individuals that have applied to a second job (and were not hired for the second job) after the first job was posted to take any necessary assessments, and go through the proper evaluation, for the first job.

FIG. 4 depicts a block diagram of components of Computing Device 110 and Candidate Device 140, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing Device 110 and Candidate Device 140 include communications fabric 902, which provides communications between computer processor(s) 904, memory 906, persistent storage 908, communications unit 912, and input/output (I/O) interface(s) 914. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses.

Memory 906 and persistent storage 908 are computer-readable storage media. In this embodiment, memory 906 includes random access memory (RAM) 916 and cache memory 918. In general, memory 906 can include any suitable volatile or non-volatile computer-readable storage media.

The programs Job Database 114, Recruitment Database 116, and Assessment Database 118, in Computing Device 110; and Candidate Interface 142 in Candidate Device 140 are stored in persistent storage 908 for execution by one or more of the respective computer processors 904 via one or more memories of memory 906. In this embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer-readable storage medium that is also part of persistent storage 908.

Communications unit 912, in these examples, provides for communications with other data processing systems or devices. In these examples, communications unit 912 includes one or more network interface cards. Communications unit 912 may provide communications through the use of either or both physical and wireless communications links. The programs Job Database 114, Recruitment Database 116, and Assessment Database 118in Computing Device 110; and Candidate Interface 142 in Candidate Device 140 may be downloaded to persistent storage 908 through communications unit 912.

I/O interface(s) 914 allows for input and output of data with other devices that may be connected to Computing Device 110 and social media Candidate Device 140. For example, I/O interface 914 may provide a connection to external devices 920 such as a keyboard, keypad, a touch screen, and/or some other suitable input device. External devices 920 can also include portable computer-readable storage media such as, for example, thumb drives, portable optical or magnetic disks, and memory cards. Software and data used to practice embodiments of the present invention, e.g., The programs Job Database 114, Recruitment Database 116, and Assessment Database 118 in Computing Device 110; and Candidate Interface 142 in Candidate Device 140, can be stored on such portable computer-readable storage media and can be loaded onto persistent storage 908 via I/O interface(s) 914. I/O interface(s) 914 can also connect to a display 922.

Display 922 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Candidate Search Program 96.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A computer-implemented method for determining an aptitude of a job candidate, the computer-implemented method comprising:
receiving a job role;
determining characteristics associated with the job role;
determining a job candidate that meets a threshold number of the characteristics;
creating an assessment to test the characteristics, wherein creating the assessment comprises combining a plurality of questions based on a relevance of each question to the characteristic, and wherein the plurality of questions are questions the job candidate does not have a valid assessment score for the characteristic; and
determining an aptitude of the job candidate based on answers provided to the plurality of questions.

2. The computer-implemented method of claim 1, wherein determining characteristics associated with the job role comprises:
analyzing related job roles; and
determining characteristics possessed by job recipients of the related job role.

3. The computer-implemented method of claim 2 further comprising determining characteristics possessed by job recipients that receive high performance ratings.

4. The computer-implemented method of claim 1, wherein determining a job candidate comprises comparing characteristics stored in a database for the job candidate to characteristics associated with the job role and returning the job candidate when the threshold number of characteristics match.

5. The computer-implemented method of claim 1, wherein the questions the job candidate does not have a valid assessment score for the characteristic comprises:
questions for a characteristic that the job candidate has previously not passed an assessment; and
questions for a characteristic that the job candidate has not taken an assessment.

6. The computer-implemented method of claim 1, wherein the job candidate has not applied to the job role.

7. The computer-implemented method of claim 1, wherein the aptitude of the job candidate is based on a weighted scoring of the plurality of questions, wherein the weighted scoring is based on the correlation between the characteristic a question measures and job recipients that receive high performance ratings.

8. A computer program product for determining an aptitude of a job candidate, the computer program product comprising:
one or more computer-readable storage devices and program instructions stored on at least one of the one or more tangible storage devices, the program instructions comprising:
receiving a job role;
determining characteristics associated with the job role;
determining a job candidate that meets a threshold number of the characteristics;
creating an assessment to test the characteristics, wherein creating the assessment comprises combining a plurality of questions based on a relevance of each question to the characteristic, and wherein the plurality of questions are questions the job candidate does not have a valid assessment score for the characteristic; and
determining an aptitude of the job candidate based on answers provided to the plurality of questions.

9. The computer program product of claim 8, wherein determining characteristics associated with the job role comprises:
analyzing related job roles; and
determining characteristics possessed by job recipients of the related job role.

10. The computer program product of claim 9 further comprising determining characteristics possessed by job recipients that receive high performance ratings.

11. The computer program product of claim 8, wherein determining a job candidate comprises comparing characteristics stored in a database for the job candidate to characteristics associated with the job role and returning the job candidate when the threshold number of characteristics match.

12. The computer program product of claim 8, wherein the questions the job candidate does not have a valid assessment score for the characteristic comprises:
questions for a characteristic that the job candidate has previously not passed an assessment; and
questions for a characteristic that the job candidate has not taken an assessment.

13. The computer program product of claim 8, wherein the job candidate has not applied to the job role.

14. The computer program product of claim 8, wherein the aptitude of the job candidate is based on a weighted scoring of the plurality of questions, wherein the weighted scoring is based on the correlation between the characteristic a question measures and job recipients that receive high performance ratings.

15. A computer system for determining an aptitude of a job candidate, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
receiving a job role;
determining characteristics associated with the job role;
determining a job candidate that meets a threshold number of the characteristics;
creating an assessment to test the characteristics, wherein creating the assessment comprises combining a plurality of questions based on a relevance of each question to the characteristic, and wherein the plurality of questions are questions the job candidate does not have a valid assessment score for the characteristic; and
determining an aptitude of the job candidate based on answers provided to the plurality of questions.

16. The computer system of claim 15, wherein determining characteristics associated with the job role comprises:
analyzing related job roles; and
determining characteristics possessed by job recipients of the related job role.

17. The computer system of claim 16 further comprising determining characteristics possessed by job recipients that receive high performance ratings.

18. The computer system of claim 15, wherein determining a job candidate comprises comparing characteristics stored in a database for the job candidate to characteristics associated with the job role and returning the job candidate when the threshold number of characteristics match.

19. The computer system of claim 15, wherein the questions the job candidate does not have a valid assessment score for the characteristic comprises:
questions for a characteristic that the job candidate has previously not passed an assessment; and
questions for a characteristic that the job candidate has not taken an assessment.

20. The computer system of claim 15, wherein the job candidate has not applied to the job role.
